(19) United States
(12) Patent Application Publication
(10) Pub. No.: US 2012/0139988 A1
(43) Pub. Date: Jun. 7, 2012

(54) IMAGE FORMING APPARATUS AND CONTROL METHOD OF THE IMAGE FORMING APPARATUS

(75) Inventors: Satoshi Kaiho, Kanagawa (JP); Kazuhiro Hara, Shizuoka (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/308,667

(22) Filed: Dec. 1, 2011

Related U.S. Application Data
(60) Provisional application No. 61/418,634, filed on Dec. 1, 2010.

(30) Foreign Application Priority Data
Jun. 10, 2011 (JP) 2011-129946

(51) Int. Cl. B41J 29/38

(52) U.S. Cl. 347/16

(57) ABSTRACT

An image forming apparatus includes: an image forming section configured to form an image on a recording medium; a paper discharge path through which the recording medium subjected to the image formation by the image forming section is conveyed; plural paper discharge sections provided in the paper discharge path and including rollers that convey the conveyed recording medium while changing a rotating direction to a first direction, which is a paper discharge direction, and a second direction, which is an opposite direction; a path changing section configured to selectively change a conveying path for conveying the recording medium to the plural paper discharge sections; and a control section configured to control the rotating direction of the roller and the changing operation of the path changing section.

### CROSS-REFERENCE TO RELATED APPLICATION

This application is based upon and claims the benefit of priority from U.S. Provisional Patent Application 61/418,634 filed on Dec. 1, 2010, the entire contents of which are incorporated herein by reference.

This application is based upon and claims the benefit of priority from the prior Japanese Patent Application No. 2011-129946 field on Jun. 10, 2011, the entire contents of which are incorporated herein by reference.

### FIELD

Embodiments described herein relate generally to an image forming apparatus.

### BACKGROUND

There is known an image forming apparatus that includes two paper discharge sections and uses one paper discharge section for reversal and uses the other exclusively for paper discharge in order to secure, in printing images on both sides of a sheet, printing performance during duplex printing.

However, if both sides of plural sheets are subjected to image formation, while the preceding sheet is reversed, a sheet to be reversed next needs to be put on standby before a reversing path. Therefore, printing performance falls.

### DESCRIPTION OF THE DRAWINGS

FIG. 1 is a configuration diagram of an image forming apparatus according to a first embodiment;

FIG. 2 is an enlarged view of an internal structure of an image forming apparatus according to the first embodiment;

FIG. 3 is a block diagram of a control system of the image forming apparatus according to the first embodiment;

FIG. 4 is an enlarged view of a paper discharge section of the image forming apparatus according to the first embodiment;

FIG. 5 is a flowchart for explaining image formation on both sides of a sheet in the first embodiment;

FIG. 6 is a diagram of a path changing section configured to convey a first sheet to a first paper discharge section in the first embodiment;

FIG. 7 is a diagram of a path changing section configured to reverse the first sheet and convey a second sheet to a second paper discharge section in the first embodiment;

FIG. 8 is a diagram of a path changing section configured to reverse the second sheet and conveys the second sheet in the first embodiment;

FIG. 9 is a flowchart for explaining a series of flow in the image forming apparatus according to the first embodiment;

FIG. 10 is a diagram in which a sheet conveyed to a drum in the first embodiment is shown;

FIG. 11 is a diagram in which the sheet subjected to image formation in the first embodiment is shown;

FIG. 12 is a diagram in which the sheet conveyed to the paper discharge section after the image formation in the first embodiment is shown;

FIG. 13 is a diagram in which the first sheet is conveyed to the first paper discharge section and the second sheet is conveyed to the second paper discharge section in the first embodiment;

FIG. 14 is a diagram in which the first sheet is reversed and the second sheet is conveyed to the second paper discharge section in the first embodiment;

FIG. 15 is a diagram in which the second sheet is reversed and the first sheet and the second sheet are conveyed to the drum again in the first embodiment;

FIG. 16 is a diagram showing a state in which the first sheet and the second sheet are put on standby after image formation on one side in the first embodiment; and

FIG. 17 is an enlarged view of a paper discharge section of an image forming apparatus according to a second embodiment.

### DETAILED DESCRIPTION

According to an embodiment, an image forming apparatus includes an image forming section configured to form an image on a recording medium. A paper discharge path through which the recording medium subjected to the image formation by the image forming section is conveyed. Plural paper discharge sections provided in the paper discharge path and including rollers that convey the conveyed recording medium while changing a rotating direction to a first direction, which is a paper discharge direction, and a second direction, which is an opposite direction. A path changing section configured to selectively change a conveying path for conveying the recording medium to the plural paper discharge sections. A control section configured to control the rotating direction of the roller and the changing operation of the path changing section.

Image forming apparatuses according to embodiments are explained below with reference to the accompanying drawings.

### First Embodiment

In an image forming apparatus including two paper discharge sections according to the first embodiment, the two paper discharge sections include a reversing function.

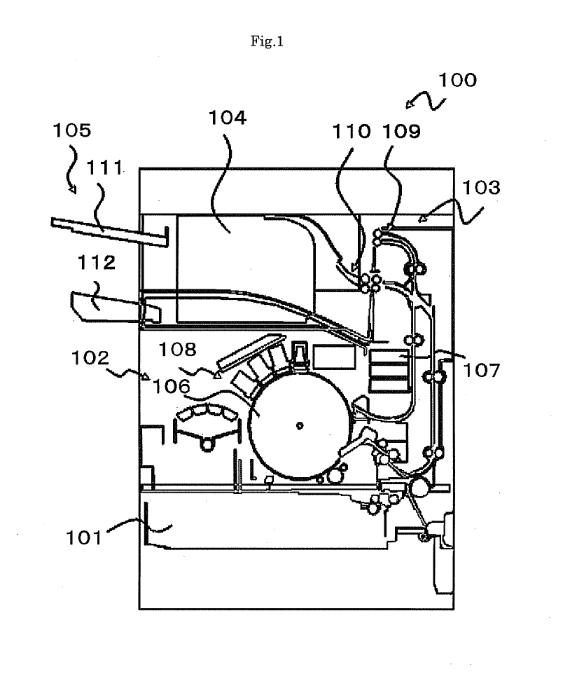

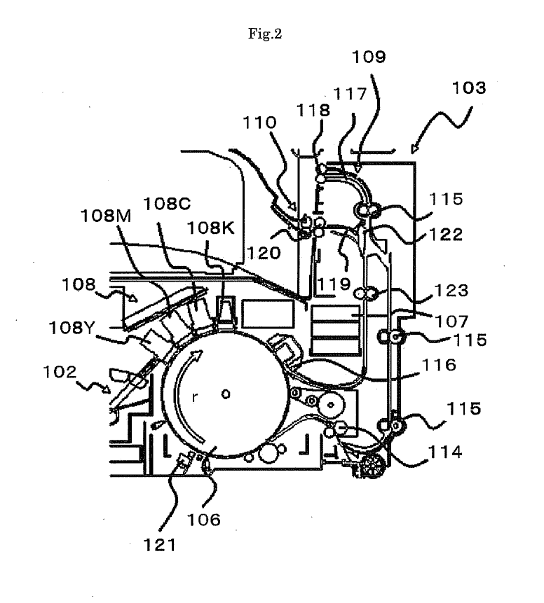

FIG. 1 is a configuration diagram of the image forming apparatus according to the first embodiment. FIG. 2 is an enlarged view of an internal structure of an image forming apparatus 100. The image forming apparatus is, for example, an MFP (Multi-Function Peripheral), which is a complex machine, a printer, or a copying machine.

The image forming apparatus 100 includes a storing section 101, an image forming section 102, a paper discharge section 103, a finishing section 104, and a stacking section 105.

The storing section 101 stores sheets, which are recording media, and can be drawn out in a direction toward the viewer in FIG. 1. The image forming section 102 ejects water based ink and forms an image on the surface of a sheet. The image forming section 102 includes a drum 106, an ink supply section 107, and inkjet heads 108. The circumferential length of the drum 106 is of a length sufficient for sticking at least two sheets thereto. The drum 106 rotates in the direction depicted by arrow r. In order to attract a sheet, the drum 106 generates negative pressure on the inside of the drum and attracts the sheet through holes opened on the drum 106. As another attracting method, for example, the drum 106 can generate static electricity to attract a sheet.

The inkjet heads 108 that eject inks to a sheet according to image data are arranged in four rows above the drum 106. For example, inkjet head 108Y ejects yellow (Y) ink, inkjet head 108M ejects magenta (M) ink, inkjet head 108C ejects cyan (C) ink, and inkjet head 108K ejects black (K) ink are arranged in this order from an upstream direction.

The ink supply section 107 stores color inks and is coupled to the inkjet heads 108 by tubes. In the configuration explained above, image formation is performed with the inks of the plural colors of yellow, magenta, cyan, and black. However, the image formation is not limited to this configuration. A configuration for performing the image formation with ink of a single color can be adopted.

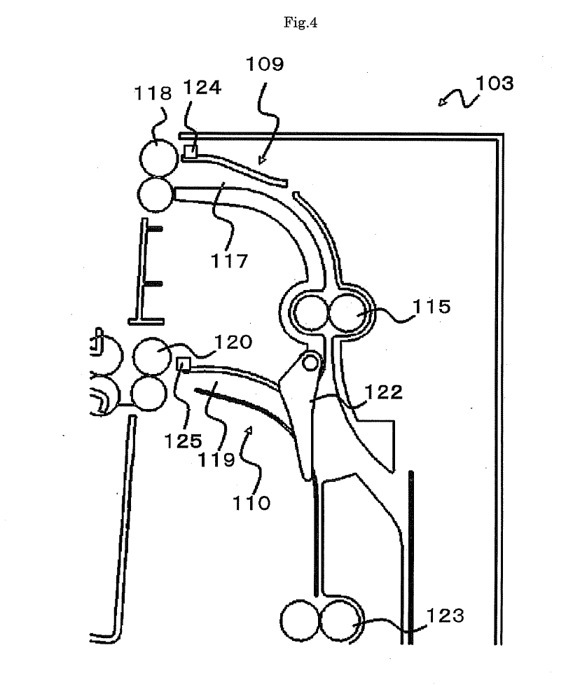

The paper discharge section 103 includes a first paper discharge section 109 and a second paper discharge section 110. The first paper discharge section 109 and the second paper discharge section 110 include a reversing function. The first paper discharge section 109 is located in a position apart from the image forming section 102 compared with the second paper discharge section 110. The paper discharge section 103 is explained later with reference to FIG. 4.

The finishing section 104 applies finishing such as stapling, punching, saddle folding, fold reinforcing, and the like to sheets subjected to image formation by the image forming section 102 and discharged from the paper discharge section 103.

The sheets discharged from the paper discharge section 103 and the sheets subjected to the finishing by the finishing section 104 and discharged are stacked on the stacking section 105. The stacking section 105 includes a first stacking section 111 and a second stacking section 112. The discharged sheets are stacked on the first stacking section 111 or the second stacking section 112.

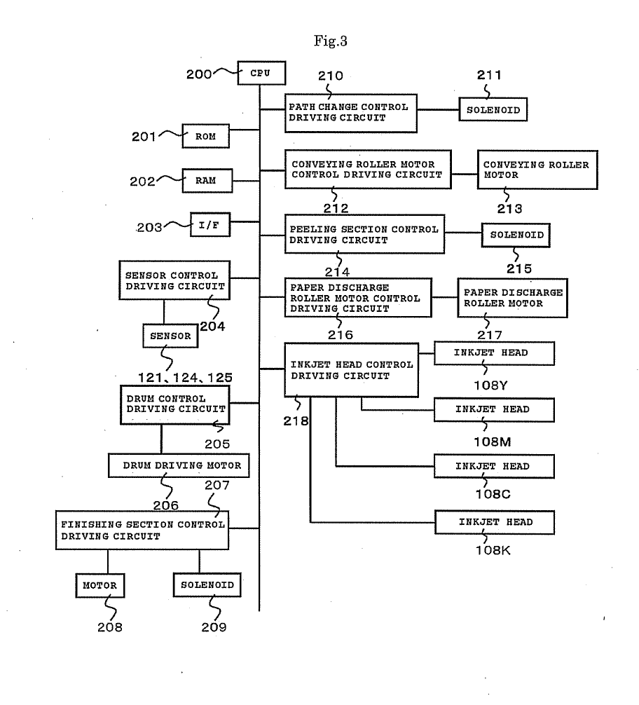

FIG. 3 is a block diagram of the image forming apparatus 100. The image forming apparatus 100 includes a CPU (Central Processing Unit) 200, which is a control section, a ROM (Read Only Memory) 201 having various computer programs and the like stored therein, a RAM (Random Access Memory) 202 that temporarily stores various variable data, image data, and the like, and an interface (I/F) 203 that receives input of data from the outside and outputs data to the outside.

Further, the image forming apparatus 100 includes a sensor control driving circuit 204 that controls sensors 121, 124, and 125, a drum control driving circuit 205 that controls a drum driving motor 206 coupled to the drum 106, a finishing section control driving circuit 207 that controls a motor 208 and a solenoid 209 that drives stapling, punching, saddle folding, fold reinforcing, and the like by the finishing section 104, a path change control driving circuit 210 that controls a solenoid 211 coupled to a path changing section 122 that selectively changes a conveying path for a sheet, a conveying roller motor control driving circuit 212 that controls a conveying roller motor 213 coupled to a registration roller 114 and conveying roller pairs 115 and 123, a peeling section control driving circuit 214 that controls a solenoid 215 coupled to a peeling section 116 that peels a sheet off the drum 106, a paper discharge roller motor control driving circuit 216 that controls a paper discharge roller motor 217 coupled to a first paper discharge roller 118 and a second paper discharge roller 120, and an inkjet head control driving circuit 218 that controls inkjet head 108Y, inkjet head 108M, inkjet head 108C, and inkjet head 108K.

The CPU 200 is connected to the ROM 201, the RAM 202, the I/F 203, the sensor control driving circuit 204, the drum control driving circuit 205, the finishing section control driving circuit 207, the path change control driving circuit 210, the conveying roller motor control driving circuit 212, the peeling section control driving circuit 214, the paper discharge roller motor control driving circuit 216, and the inkjet head control driving circuit 218 via a bus.

The sensors 121, 124, and 125 detect passage of a sheet. A detection result is transmitted to the CPU 200 via the sensor control driving circuit 204. Inkjet head 108Y, inkjet head 108M, inkjet head 108C, and inkjet head 108K eject inks to the sheet from nozzles on the basis of signals from the inkjet head control driving circuit 218.

The image forming apparatus 100 according to the first embodiment forms images on both sides of a set of two sheets: a first sheet P1 and a second sheet P2. The first sheet subjected to image formation from the set of two sheets is the first sheet P1 and the sheet subjected to image formation after the first sheet P1 is the second sheet P2.

FIG. 4 is an enlarged view of the paper discharge section 103. The paper discharge section 103 includes the first paper discharge section 109, the second paper discharge section 110, the conveying roller pairs 115 and 123, and the path changing section 122. The first paper discharge section 109 includes a first paper discharge path 117, the first paper discharge roller 118, and the sensor 124. The second paper discharge section 110 includes a second paper discharge path 119, the second paper discharge roller 120, and the sensor 125. The first paper discharge path 117 is a paper discharge path for causing a sheet to pass. The sensor 124 detects the passage of the sheet. The first paper discharge roller 118 conveys and reversely conveys the sheet. The second paper discharge path 119 is a paper discharge path for causing a sheet to pass. The sensor 125 detects the passage of the sheet P2. The second paper discharge roller 120 conveys and reversely conveys the sheet. The conveying roller pairs 115 and 123 convey and reversely convey the sheet.

The path changing section 122 is driven by the solenoid 211 and pivots about a shaft to thereby change a conveying path for a sheet. There are three stop positions of the path changing section 122. A first stop position is an upper paper discharge position, a second stop position is a lower paper discharge position, and a third stop position is a lower reversal paper discharge position. The upper paper discharge position is a position where the first sheet P1 after image formation is conveyed to the first paper discharge position 109. The lower paper discharge position is a position where the second sheet P2 after image formation is conveyed to the second paper discharge section 110 and the first sheet P1 is conveyed to the image forming section 102 again. The lower reversal paper discharge position is a position where the second sheet P2 is conveyed to the image forming section 102 again.

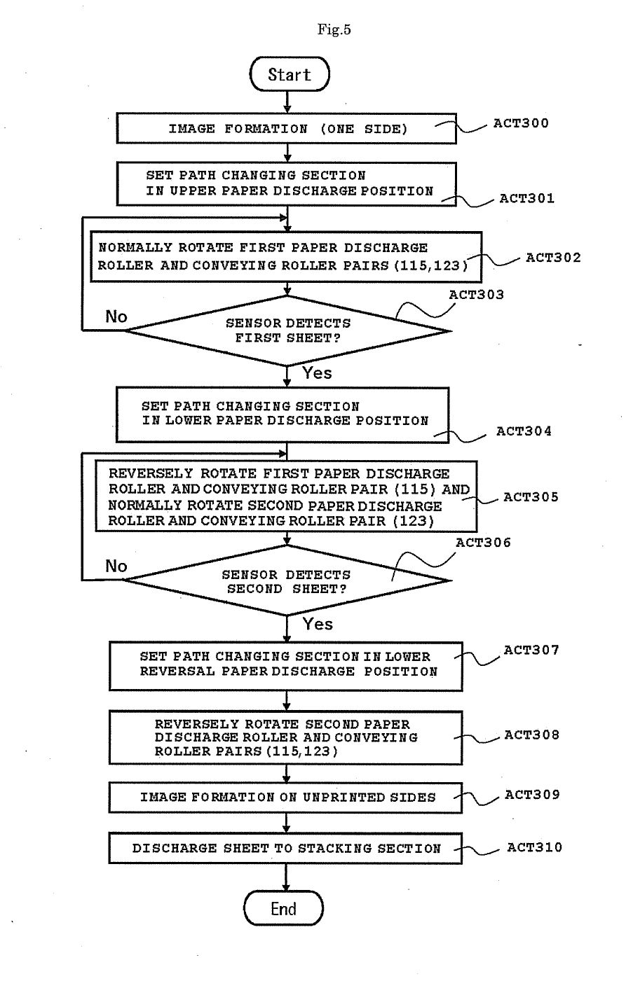

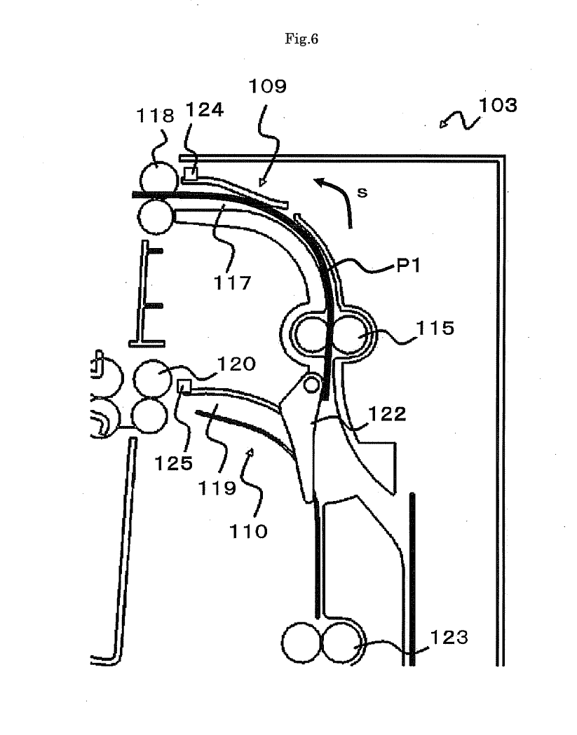

FIG. 5 is a flowchart for explaining reversal of a sheet involved in duplex printing. In Act 300, the image forming apparatus 100 subjects each one side of the first sheet P1 and the second sheet P2 to image formation. In Act 301, the image forming apparatus 100 sets the path changing section 122 in the upper paper discharge position. In Act 302, the image forming apparatus 100 rotates the first paper discharge roller 118 and the conveying roller pairs 115 and 123 in a normal direction. FIG. 6 is a diagram of the path changing section 122 located in the upper paper discharge position. When the path changing section 122 is located in the upper paper discharge position, the image forming apparatus 100 rotates the first paper discharge roller 118 and the conveying roller pairs 115 and 123 in the normal direction to convey the first sheet P1 in a direction depicted by arrow s.

Thereafter, in Act 303 in FIG. 5, the image forming apparatus 100 determines whether the sensor 124 detects the first sheet P1. If the sensor 124 does not detect the first sheet P1 (No in Act 303), the image forming apparatus 100 returns to Act 302. The image forming apparatus 100 repeats the determination until the sensor 124 detects the first sheet P1 (Yes in 303).

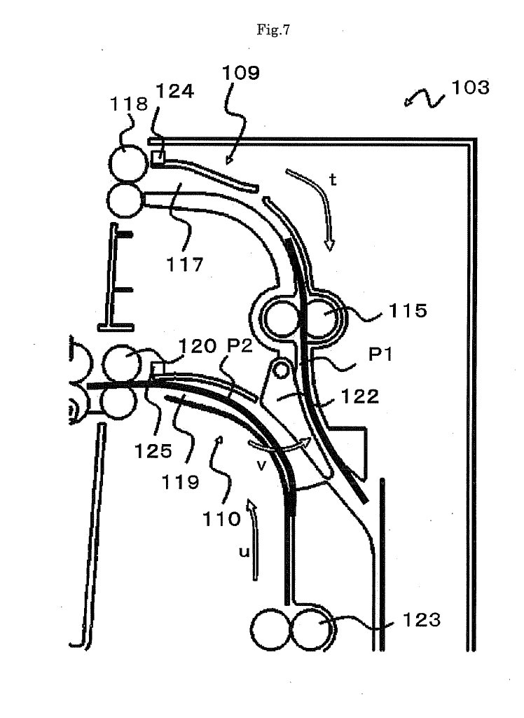

If the sensor 124 detects the first sheet P1 (Yes in Act 303), in Act 304, the image forming apparatus 100 stops the rotation of the first paper discharge roller 118 to stop the conveyance of the first sheet P1 and sets the path changing section 122 in the lower paper discharge position. In Act 305, the image forming apparatus 100 rotates the first paper discharge roller 118 and the conveying roller pair 115 in a direction opposite to the normal direction and rotates the second paper discharge roller 120 and the conveying roller pair 123 in the normal direction. FIG. 7 is a diagram of the path changing section 122 located in the lower paper discharge position. The lower paper discharge position of the path changing section 122 is a position shifted in an arrow v direction from the upper paper discharge position shown in FIG. 6. When the path changing section 122 is located in the lower paper discharge position, the image forming apparatus 100 rotates the first paper discharge roller 118 and the conveying roller pair 115 in the direction opposite to the normal direction to convey the first sheet P1 in an arrow t direction. Further, the image forming apparatus 100 rotates the second paper discharge roller 120 and the conveying roller pair 123 in the normal direction to convey the second sheet P2 in an arrow u direction.

Thereafter, in Act 306 in FIG. 5, the image forming apparatus 100 determines whether the sensor 125 detects the second sheet P2. If the sensor 125 does not detect the second sheet P2 (No in Act 306), the image forming apparatus 100 returns to Act 305 and repeats the determination until the sensor 125 detects the second sheet P2 (Yes in Act 306).

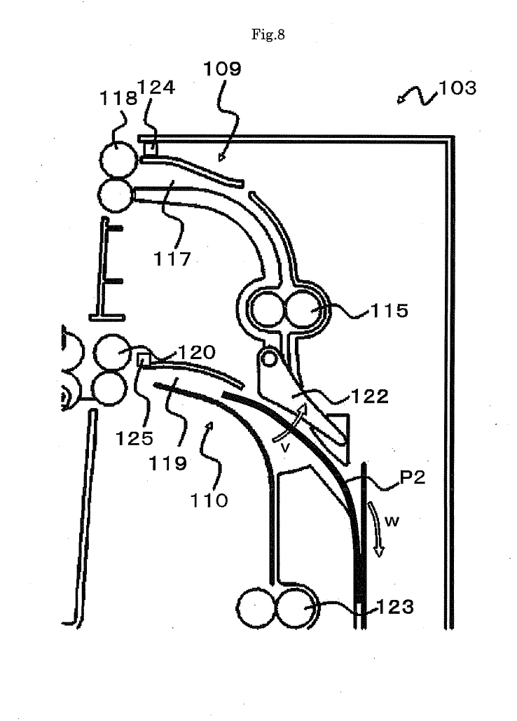

If the sensor 125 detects the second sheet P (Yes in Act 306), in Act 307, the image forming apparatus 100 stops the rotation of the second paper discharge roller 119 to stop the conveyance of the second sheet P2 and sets the path changing section 122 in the lower reversal paper discharge position. In Act 308, the image forming apparatus 100 rotates the second paper discharge roller 120 and the conveying roller pairs 115 and 123 in the direction opposite to the normal direction. FIG. 8 is a diagram of the path changing section 122 located in the lower reversal paper discharge position. The lower reversal paper discharge position of the path changing section 122 is a position further shifted in the arrow v direction from the lower paper discharge position shown in FIG. 7. When the path changing section 122 is located in the lower reversal paper discharge position, the image forming apparatus 100 rotates the second paper discharge roller 120 and the conveying roller pairs 115 and 123 in the direction opposite to the normal direction to convey the second sheet P2 in an arrow w direction.

Thereafter, in Act 309 in FIG. 5, the image forming apparatus 100 subjects unprinted sides of the first sheet P1 and the second sheet P2 to image formation. In Act 310, the image forming apparatus 100 discharges the first sheet P1 and the second sheet P2 subjected to the duplex printing to the stacking section 105 via the second paper discharge section 110.

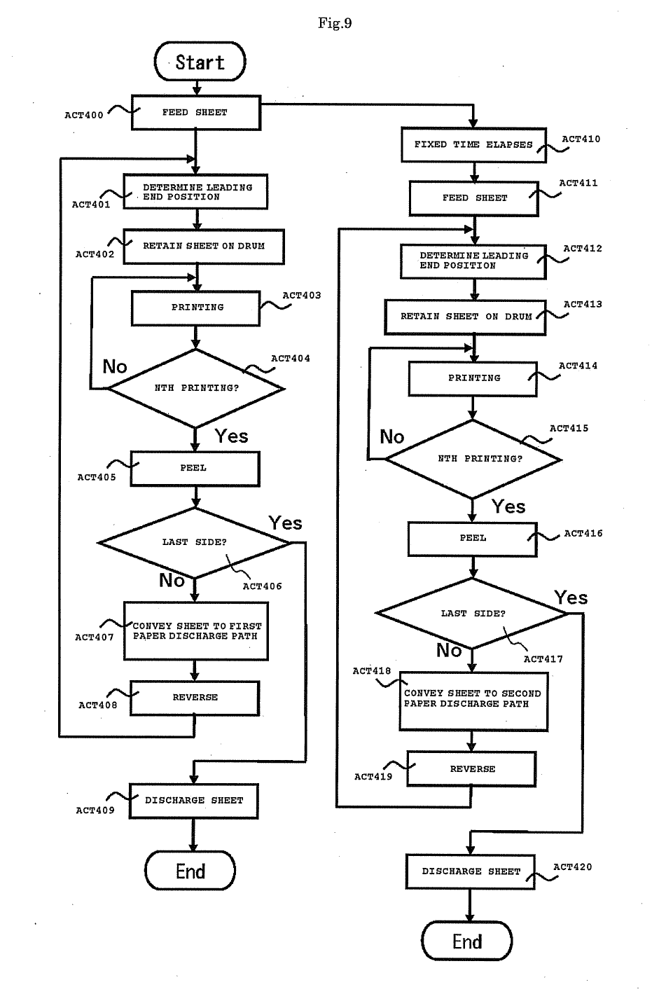

A series of flow of the image forming apparatus during the duplex printing is explained below with reference to a flowchart of FIG. 9. If a printing instruction is given from the CPU 200, which is the control section, in Act 400, the image forming apparatus 100 feeds the first sheet P1 from the storing section 101. In Act 401, the registration roller 114 determines a leading end position of the fed first sheet P1. If the first sheet P1 reaches the registration roller 114 and a fixed time elapses, the registration roller 114 delivers the first sheet P1. In Act 402, the image forming apparatus 100 retains the first sheet P1 on the drum 106. The first sheet P1 is conveyed according to the rotation of the drum 106 that rotates in the arrow r direction. The first sheet P1 is retained on the drum 106 by electrostatic attraction or negative pressure attraction.

In Act 403, the image forming apparatus 100 applies printing to the first sheet P1 retained on the drum 106. If the sensor 121 detects passage of the first sheet P1, the sensor 121 transmits a detection signal to the CPU 200. If a predetermined time elapses after the detection signal is transmitted, the image forming apparatus 100 determines that the first sheet P1 reaches a predetermined position and drives the inkjet heads 108 according to a control signal. The driven inkjet heads 108 eject the inks and form a first image on the first sheet P1. After the first image is formed, the inkjet heads 108 move in a direction orthogonal to a conveying direction of the first sheet P1 by a predetermined distance.

The first sheet P1 having the first image formed thereon rotates according to the rotation of the drum 106 and reaches a detection position of the sensor 121 again. Thereafter, if the predetermined time elapses after the detection signal is transmitted, the image forming apparatus 100 drives the inkjet heads 108 according to the control signal. The driven inkjet heads 108 eject the inks and form a second image. Thereafter, the image forming apparatus 100 performs a cycle of the movement of the inkjet heads 108 and the printing a necessary number of times n and superimposes first to nth images one on top of another on one side of the sheet to form the sheet.

In Act 404, the image forming apparatus 100 determines whether the nth printing ends. If the nth printing does not end (No in Act 404), in Act 403, the image forming apparatus 100 repeats the printing. If the nth printing ends (Yes in Act 404), in Act 405, the image forming apparatus 100 actuates the solenoid 215 of the peeling section 116 and peels the first sheet P1. A peeling claw in contact with the drum 106 tears up the leading end of the first sheet P1 and peels the first sheet P1 off the drum 106.

In Act 406, the image forming apparatus 100 determines whether image formation on a last side of the first sheet P1 peeled off the drum 106 ends. If the image formation on the last side ends (Yes in Act 406), in Act 409, the image forming apparatus 100 discharges the first sheet P1 to the stacking section 105 via the paper discharge section 103 and ends the printing.

If the image formation on the last side does not end (No in Act 406), in Act 407, the image forming apparatus 100 conveys the first sheet P1 to the first paper discharge path 117. In Act 408, the image forming apparatus 100 reverses the first sheet P1. After the reversal, the image forming apparatus 100 returns to Act 401 and performs image formation on a side not subjected to the image formation.

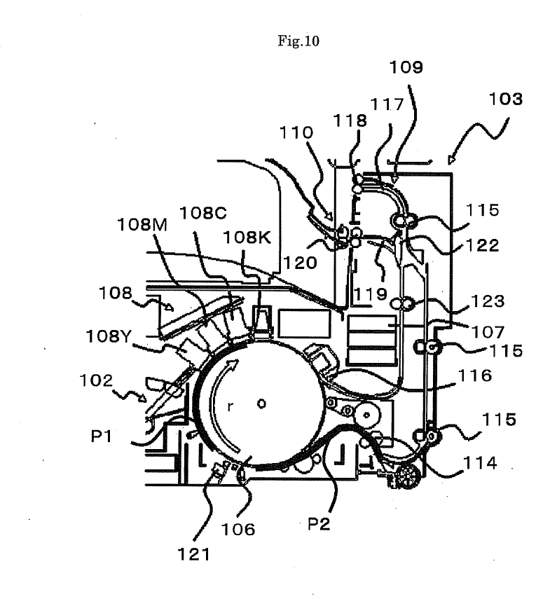

After a fixed time elapses in Act 410 after the first sheet P1 is fed from the storing section 101 in Act 400, in Act 411, the image forming apparatus 100 feeds the second sheet P2 from the storing section 101. In Act 412, the registration roller 114 determines a leading end position of the fed second sheet P2. If the second sheet P2 reaches the registration roller 114 and a fixed time elapses, the registration roller 114 delivers the second sheet P2. In Act 413, the image forming apparatus 100 retains the second sheet P2 on the drum 106. The second sheet P2 is conveyed according to the rotation of the drum 106 that rotates in the arrow r direction. As shown in FIG. 10, the second sheet P2 is conveyed together with the first sheet P1. The sheets are retained on the drum 106 by electrostatic attraction or negative pressure attraction.

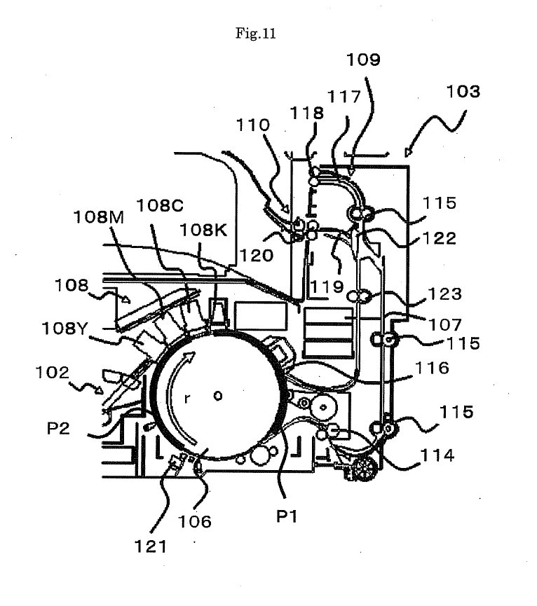

In Act 414 in FIG. 9, the image forming apparatus 100 subjects the second sheet P2 retained on the drum 106 to image formation in a method same as the method for the first sheet P1. As shown in FIG. 11, the image forming apparatus 100 retains the first sheet P1 and the second sheet P2 on the drum 106 and subjects the sheets to the image formation.

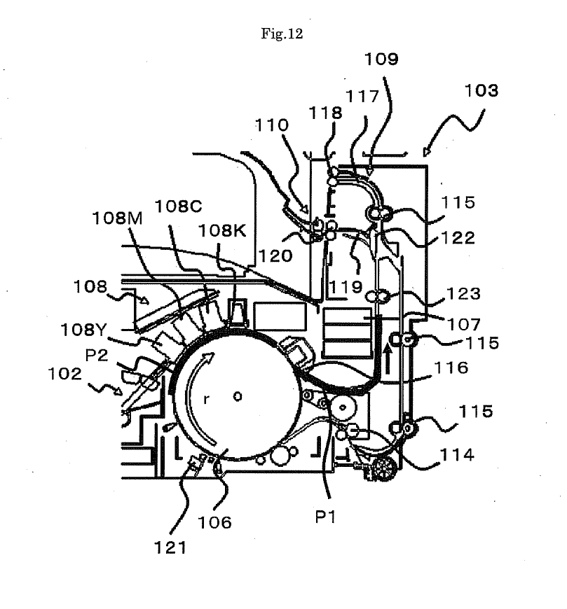

In Act 415 in FIG. 9, the image forming apparatus 100 determines whether nth printing ends. If the nth printing does not end (No in Act 415), in Act 414, the image forming apparatus 100 repeats the printing. If the nth printing ends (Yes in Act 415), in Act 416, the image forming apparatus 100 actuates the solenoid 215 of the peeling section 116 and peels the first sheet P1 off the drum 106. Following the peeling of the first sheet P1, the peeling claw in contact with the drum 106 tears up the leading end of the second sheet P2 and peels the second sheet P2 off the drum 106. FIG. 12 is a diagram of a state in which the sheet P1 is peeled off the drum 106 by the peeling section 116.

In Act 417 in FIG. 9, the image forming apparatus 100 determines whether image formation on a last side of the second sheet P2 peeled off the drum 106 ends. If the image formation on the last side ends (Yes in Act 417), in Act 420, the image forming apparatus 100 discharges the second sheet P2 to the stacking section 105 via the paper discharge section 103 and ends the printing.

If the image formation on the last side does not end (No in Act 417), in Act 418, the image forming apparatus 100 conveys the second sheet P2 to the second paper discharge path 119. In Act 419, the image forming apparatus 100 reverses the second sheet P2. After the reversal, the image forming apparatus 100 returns to Act 412 and performs image formation on a side not subjected to the image formation.

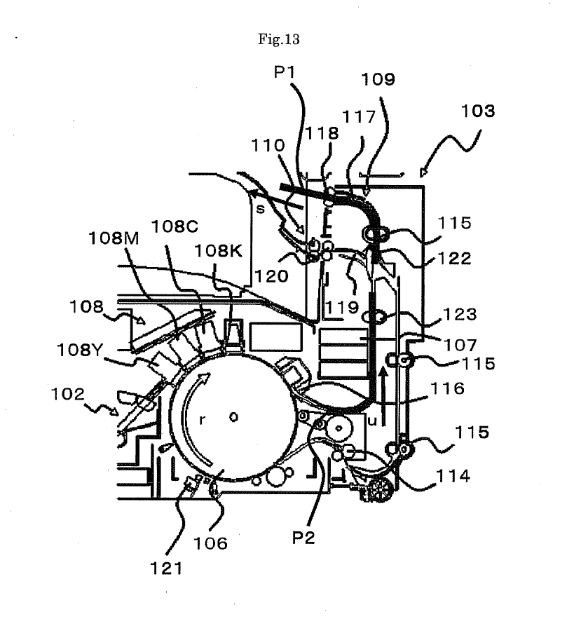

A flow of conveyance of the first sheet P1 and the second sheet P2 after the peeling is explained with reference to FIGS. 13, 14, 15, and 16. FIG. 13 is a diagram in which the first sheet P1 is conveyed to the first paper discharge section 109 and the second sheet P2 is conveyed to the second paper discharge section 110. The first sheet P1 is conveyed in the arrow s direction and the second sheet P2 is conveyed in the arrow u direction.

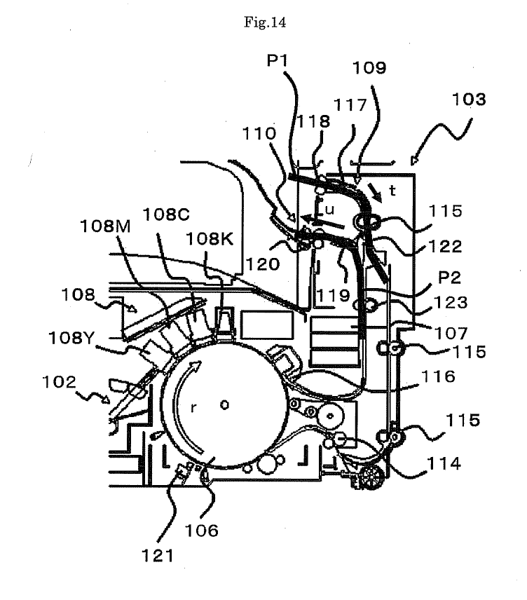

FIG. 14 is a diagram in which the first sheet P1 is reversed and the second sheet P2 is conveyed to the second paper discharge section 110. The first sheet P1 conveyed to the first paper discharge section 109 and detected by the sensor 124 is conveyed in the arrow t direction opposite to the arrow s direction. The second sheet P2 is conveyed to the second paper discharge section 110.

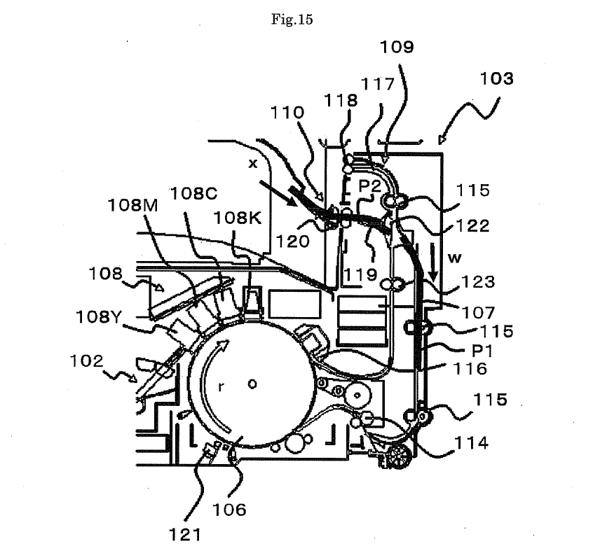

FIG. 15 is a diagram in which the second sheet P2 is reversed and the first sheet P1 and the second sheet P2 are conveyed to the image forming section 102 again. The reversed and conveyed first sheet P1 is conveyed in the direction of arrow w. The second sheet P2 conveyed to the second paper discharge section 110 and detected by the sensor 125 is conveyed in the direction of arrow x opposite to the arrow u direction.

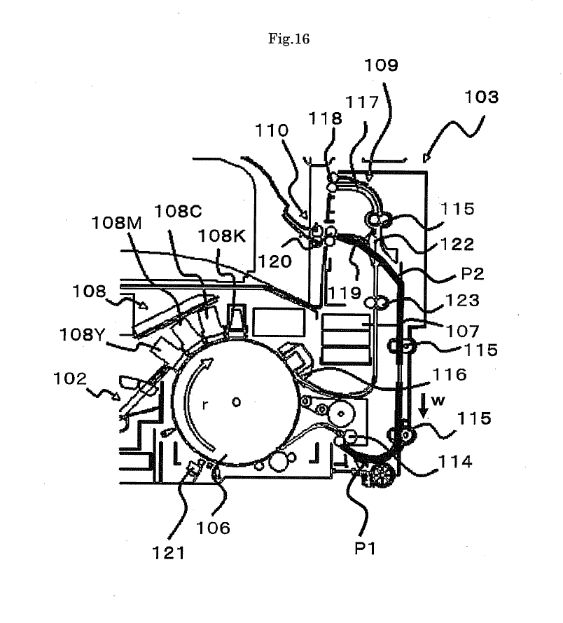

FIG. 16 is a diagram of a state in which the first sheet P1 and the second sheet P2 after image formation on each one side thereof are put on standby. Following the first sheet P1, the reversed and conveyed second sheet P2 is conveyed in the direction of arrow w. After the reversal of the first sheet P1 in Act 408 and after the reversal of the second sheet P2 in Act 419, the first sheet P1 is put on standby before the registration roller 114 and the second sheet P2 is put on standby in a position apart from the first sheet P1 by a predetermined distance. Thereafter, the image forming apparatus 100 starts a printing operation at a predetermined timing, performs image formation on a second side, and performs paper discharge.

If the image forming apparatus 100 subjects three or more sheets to image formation, during the reversing operation explained above, the image forming apparatus 100 retains third and subsequent sheets, for example, a third sheet P3 and a fourth sheet P4 on the drum 106 and subjects the sheets to image formation according to a procedure same as the procedure for the first sheet P1 and the second sheet P2. When the third sheet P3 is peeled, the first sheet P1 is put on standby in a registration position and the second sheet P2 is put on standby behind the first sheet P1. Thereafter, while the image forming apparatus 100 is performing a reversing operation for the third sheet P3 and the fourth sheet P4, the image forming apparatus 100 subjects the first sheet P1 and the second sheet P2 to image formation on a second side and discharges the sheets. Thereafter, when the image forming apparatus 100 subjects a fifth sheet P5 and a sixth sheet P6 to image formation, the image forming apparatus 100 repeats the same procedure. Even if the image forming apparatus 100 subjects three or more sheets to image formation, the image forming apparatus 100 repeats the image formation according to the same procedure. If the image forming apparatus 100 subjects only one side of a sheet to image formation rather than both sides of the sheet, the image forming apparatus 100 discharges the sheet from the second paper discharge section 110 without performing the reversing operation in the paper discharge section 103.

The image forming apparatus 100 explained above can reverse the second sheet P2 without waiting for the reversal of the first sheet P1 and reduce a space between the first sheet P1 and the second sheet P2. Therefore, even when a set of two sheets are subjected to image formation, it is possible to secure printing performance.

In the embodiment explained above, the image forming apparatus that causes the drum to retain a sheet and causes the inkjet heads to eject inks in multiple paths to form an image is explained. However, the image forming apparatus according to the embodiment is not limited to this and only has to be an image forming apparatus that includes plural paper discharge sections having the reversing function and subjects plural sheets to image formation as a set, and conveys the sheets. For example, the image forming apparatus can cause, rather than the drum, a belt to retain a sheet or can form an image in a single path. The image forming apparatus can form an image with toners or developers containing the toners without causing the inkjet heads to discharge inks.

### Second Embodiment

In an image forming apparatus according to a second embodiment that includes three paper discharge sections and subjects a set of three sheets to image formation, the three paper discharge sections include a reversing function. In the figures, components same as those in the first embodiment are denoted by the same reference numerals and signs.

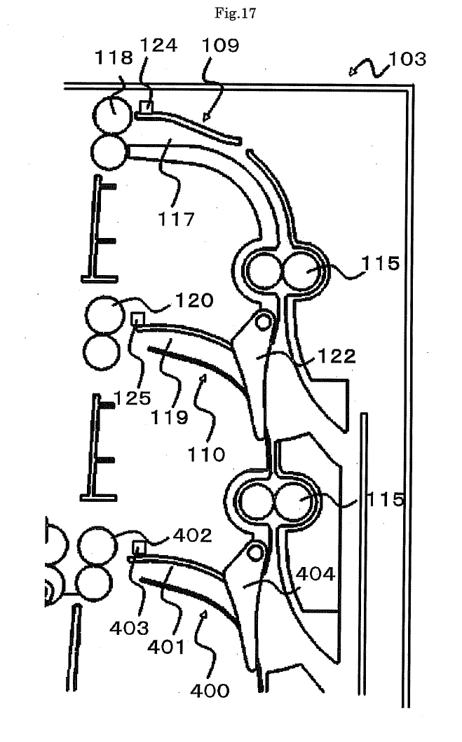

FIG. 17 is an enlarged view of the paper discharge section 103. The paper discharge section 103 includes the first paper discharge section 109, the second paper discharge section 110, a third paper discharge section 400, the conveying roller pairs 115 and 123, and path changing sections 122 and 404. The first paper discharge section 109 includes the first paper discharge path 117, the first paper discharge roller 118, and the sensor 124. The second paper discharge section 110 includes the second paper discharge path 119, the second paper discharge roller 120, and the sensor 125. The third paper discharge section 400 includes a third paper discharge path 401, a third paper discharge roller 402, and a sensor 403.

The first paper discharge path 117 is a paper discharge path for causing a sheet to pass. The sensor 124 detects the passage of the sheet. The first paper discharge roller 118 conveys and reversely conveys the sheet. The second paper discharge path 119 is a paper discharge path for causing a sheet to pass. The sensor 125 detects the passage of the sheet P2. The second paper discharge roller 120 conveys and reversely conveys the sheet. The third conveying path 401 is a paper discharge path for causing a sheet to pass. The sensor 403 detects the passage of the sheet. The third paper discharge roller 402 conveys and reversely conveys the sheet. The conveying roller pairs 115 and 123 convey and reversely convey the sheet. The path changing sections 122 and 404 are driven by the solenoid 211 and pivot about shafts to thereby change a conveying path for a sheet.

There are three stop positions of each of the path changing sections 122 and 404. A first stop position is an upper paper discharge position, a second stop position is a lower paper discharge position, and a third stop position is a lower reversal paper discharge position. The upper paper discharge position of the path changing section 122 is a position where the first sheet P1 after image formation is conveyed to the first paper discharge position 109. The lower paper discharge position of the path changing section 122 is a position where the second sheet P2 after image formation is conveyed to the second paper discharge section 110 and the first sheet P1 is conveyed to the image forming section 102 again. The lower reversal paper discharge position of the path changing section 122 is a position where the second sheet P2 is conveyed to the image forming section 102 again.

The upper paper discharge position of the path changing section 404 is a position where the first sheet P1 after image formation is conveyed to the first paper discharge position 109 and the second sheet P2 after image formation is conveyed to the second paper discharge section 110. The lower paper discharge position of the path changing section 404 is a position where the third sheet P3 after image formation is conveyed to the third paper discharge section 400. The lower reversal paper discharge position of the path changing section 404 is a position where the third sheet P3 is conveyed to the image forming section 102 again.

If the image forming apparatus 100 subjects only one side of a sheet to image formation rather than both sides of the sheet, the image forming apparatus 100 discharges the sheet from the third paper discharge section 400 without performing the reversing operation in the paper discharge section 103.

The image forming apparatus explained above can reverse the third sheet P3 without waiting for the reversal of the first sheet P1 and the second sheet P2 and reduce spaces among the first sheet P1, the second sheet P2, and the third sheet P3. Therefore, even when a set of three sheets are subjected to image formation, it is possible to secure printing performance.

In the embodiment explained above, the image forming apparatus that causes the drum to retain a sheet and causes the inkjet heads to eject inks in multiple paths to form an image is explained. However, the image forming apparatus according to the embodiment is not limited to this and only has to be an image forming apparatus that includes plural paper discharge sections having the reversing function and subjects plural sheets to image formation as a set, and conveys the sheets. For example, the image forming apparatus can cause, rather than the drum, a belt to retain a sheet or can form an image in a single path. The image forming apparatus can form an image with toners or developers containing the toners without causing the inkjet heads to discharge inks. The image forming apparatus according to the embodiment is not limited to the image forming apparatus including the three paper discharge sections and can be an image forming apparatus including three or more paper discharge sections. If an image forming apparatus includes N paper discharge sections, the image forming apparatus subjects a set of N sheets to image formation (N>3).

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image forming section configured to form an image on a recording medium;
a paper discharge path through which the recording medium subjected to the image formation by the image forming section is conveyed;
plural paper discharge sections provided in the paper discharge path, the plural paper discharge sections include rollers that convey the conveyed recording medium while changing a rotation direction to a first direction, which is a paper discharge direction, and a second direction; which is an opposite direction;
a path changing section configured to selectively change a conveying path for conveying the recording medium to the plural paper discharge sections; and
a control section configured to control the rotation direction of the roller and the changing operation of the path changing section.

2. The apparatus according to claim 1, wherein the plural paper discharge sections include a first paper discharge section and a second paper discharge section.

3. The apparatus according to claim 2, wherein the first paper discharge section includes a first sensor that detects passage of the recording medium and the second paper discharge section includes a second sensor that detects passage of the recording medium.

4. The apparatus according to claim 3, wherein, if the first sensor detects the recording medium, the apparatus stops the rotation of the roller to stop, the conveyance of the recording medium, changes the conveying path with the path changing section to convey the recording medium to the image forming section, and further changes the rotation of the roller to the second direction.

5. The apparatus according to claim 3, wherein, if the second sensor detects the recording medium, the apparatus stops the rotation of the roller to stop the conveyance of the recording medium, changes the conveying path with the path changing section to convey the recording medium to the image forming section, and further changes the rotation of the roller to the second direction.

6. The apparatus according to claim 2, wherein the first paper discharge section is located above the second paper discharge section.

7. The apparatus according to claim 6, wherein the path changing section includes a moving rotationally fulcrum that is located above the second paper discharge section.

8. The apparatus according to claim 2, when the recording medium is in both the first paper discharge section and the second paper discharge section, the control section control to convey the recording medium of the first paper discharge section to the second direction and to convey the recording medium of the second paper discharge section to the first direction.

9. The apparatus according to claim 8, when the recording medium is in both the first paper discharge section and the second paper discharge section, the path changing section is located between the recording medium in the first paper discharge section and the recording medium in the second paper discharge section.

10. An image forming apparatus that forms an image on a recording medium, the image forming apparatus comprising:
a paper discharge path through which the recording medium subjected to the image formation is conveyed; and
plural paper discharge sections provided in the paper discharge path, the plural paper discharge sections include rollers that convey the conveyed recording medium while changing a rotation direction to a first direction, which is a paper discharge direction, and a second direction, which is an opposite direction, wherein
the apparatus selectively changes a conveying path for conveying the recording medium to the plural paper discharge sections.

11. The apparatus according to claim 10, wherein the plural paper discharge sections include a first paper discharge section and a second paper discharge section.

12. A control method of a image forming apparatus includes a first conveying roller pair, a second conveying roller pair and a path changing section, comprising;
if the path changing section is in a first position, rotating the first conveying roller pair in a first direction, which is a paper discharge direction;
if the path changing section is in a second position, rotating the first conveying roller pair in a second direction, which is an opposite direction and
rotating the second conveying roller pair in the first direction, which is a paper discharge direction;
if the path changing section is in a third position, rotating the first conveying roller pair in the second direction, which is an opposite direction

13. The method of claim 12, wherein a first sensor and a second sensor are provided, and
if the first sensor detects a recording medium, locating the path changing section in the second position;
if the second sensor detects the recording medium, locating the path changing section in the third position
